(19) United States
(12) Patent Application Publication
(10) Pub. No.: US 2022/0143824 A1
(43) Pub. Date: May 12, 2022

(54) COMPUTER-READABLE RECORDING MEDIUM HAVING STORED THEREIN APPARATUS CONTROL PROGRAM, APPARATUS CONTROL METHOD, AND APPARATUS CONTROL DEVICE

(71) Applicant: FUJITSU LIMITED, Kawasaki-shi (JP)

(72) Inventors: Yasuto YOKOTA, Kawasaki (JP); Kanata SUZUKI, Kawasaki (JP)

(73) Assignee: FUJITSU LIMITED, Kawasaki-shi (JP)

(21) Appl. No.: 17/513,914

(22) Filed: Oct. 29, 2021

(30) Foreign Application Priority Data
Nov. 11, 2020 (JP) 2020-187979

(51) Int. Cl. B25J 9/16; G06K 9/62; G06N 3/04

(52) U.S. Cl. CPC B25J 9/163; G06N 3/0454; G06K 9/6256; G06K 9/6288

(57) ABSTRACT

A non-transitory computer-readable recording medium having stored therein an apparatus control program. The control program causes a computer to execute a process including, generating, by using a first machine learning model, based on first environmental information representing an operation environment of an apparatus at a first timing and first operation information representing an operation state of the apparatus at the first timing, second operation information, generating, by using a second machine learning model, based on second environmental information representing the operation environment of the apparatus at a second timing after the first timing and third operation information representing the operation state of the apparatus at the second timing, fourth operation information, controlling an operation of the apparatus based on the second operation information at a third timing after the second timing, and generating fifth operation information, by using the first machine learning model, by repeating as above.

### CROSS-REFERENCE TO RELATED APPLICATION

This application is based upon and claims the benefit of priority of the prior Japanese Patent Application No. 2020-187979, filed on Nov. 11, 2020, the entire contents of which are incorporated herein by reference.

### FIELD

The embodiment discussed herein is related to a computer-readable recording medium having stored therein an apparatus control program, an apparatus control method, and an apparatus control device.

### BACKGROUND

In recent years, in control for industrial machines or robot arms, a recurrent-type neural network such as a recurrent neural network (RNN), a long short-term memory (LSTM), or the like has been increasingly introduced to reduce teaching work.

In an apparatus control using the recurrent-type neural network, a technology in the related art is known in which posture information related to a posture of a robot arm after 1 step from a current input is predicted by using the LSTM, and the robot arm is operated by using the predicted posture information. K Suzuki, H Mori, and T Ogata, “Undefined-behavior guarantee by switching to model-based controller according to the embedded dynamics in Recurrent Neural Network”, arXiv: 2003.04862. https://arxiv.org/abs/2003.0486v1 is disclosed as related art.

### SUMMARY

According to an aspect of the embodiments, a non-transitory computer-readable recording medium having stored therein an apparatus control program for causing a computer to execute a process including generating, by using a first machine learning model, based on first environmental information representing an operation environment of an apparatus at a first timing and first operation information representing an operation state of the apparatus at the first timing, second operation information, generating, by using a second machine learning model, based on second environmental information representing the operation environment of the apparatus at a second timing after the first timing and third operation information representing the operation state of the apparatus at the second timing, fourth operation information, controlling an operation of the apparatus based on the second operation information at a third timing after the second timing, and generating fifth operation information, by using the first machine learning model, based on third environmental information representing the operation environment of the apparatus at the third timing and the second operation information, controlling the operation of the apparatus based on the fourth operation information at a fourth timing after the third timing, and controlling the operation of the apparatus based on the fifth operation information at a fifth timing after the fourth timing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an overview of an embodiment;

FIG. 2 is an explanatory diagram illustrating an example of a robot arm;

FIG. 3 is a block diagram illustrating an example of a functional configuration of an apparatus control device according to the embodiment;

FIG. 4 is a flowchart illustrating an example of preliminary work of the apparatus control device according to the embodiment;

FIG. 5 is a flowchart illustrating an example of an operation of the apparatus control device according to the embodiment;

FIG. 6 is an explanatory diagram illustrating an overview of an operation in a case of n=3; and

FIG. 7 is an explanatory diagram illustrating an example of a configuration of a computer.

### DESCRIPTION OF EMBODIMENTS

In the related art described above, a processing time in each step of predicting the posture information is a bottleneck, and for example, as an operation speed increases, the amount of change in the posture in each step is increased. As described above, when the amount of change in the posture in each step increases, there is a problem that an operation of the apparatus becomes unstable as frame by frame.

In one aspect, an object is to provide an apparatus control program, an apparatus control method, and an apparatus control device capable of realizing a stable operation of an apparatus.

Hereinafter, an apparatus control program, an apparatus control method, and an apparatus control device according to embodiments will be described with reference to the drawings. In the embodiment, components having the same functions are denoted by the same reference signs, thereby omitting redundant description thereof. The apparatus control program, the apparatus control method, and the apparatus control device which are described in the following embodiment are merely an example and are not intended to limit the embodiment. Each embodiment below may be appropriately combined to the degree with which no inconsistency is caused.

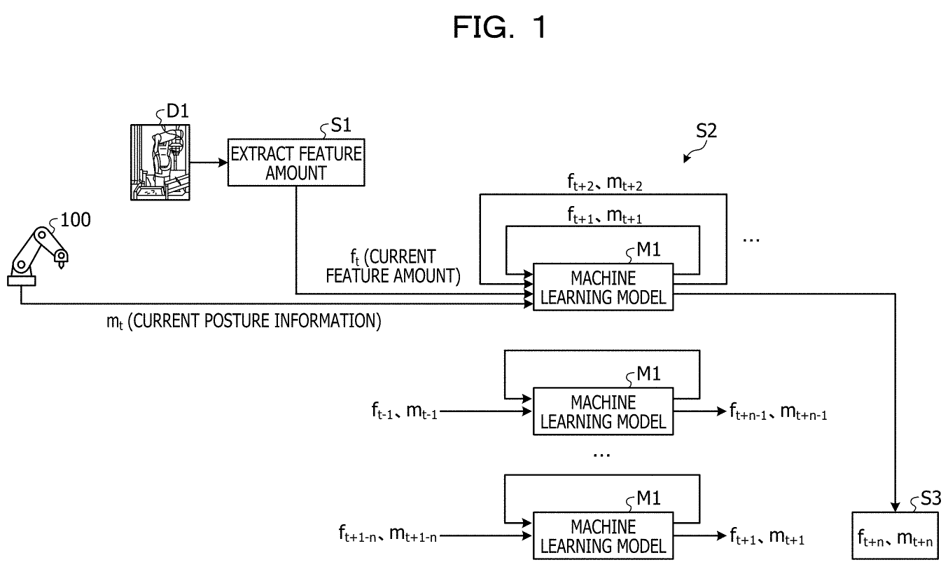

FIG. 1 is an explanatory diagram illustrating an overview of an embodiment. As illustrated in FIG. 1, in the present embodiment, control in a robot arm 100 as an example of an apparatus is performed by using a machine learning model M1 which is a recurrent-type neural network such as an RNN or LSTM. The apparatus to be controlled is not limited to the robot arm 100. For example, the machine learning model M1 may be used to control a position of a control shaft, a feed speed of a workpiece, a machining speed, and the like in an automatic lathe.

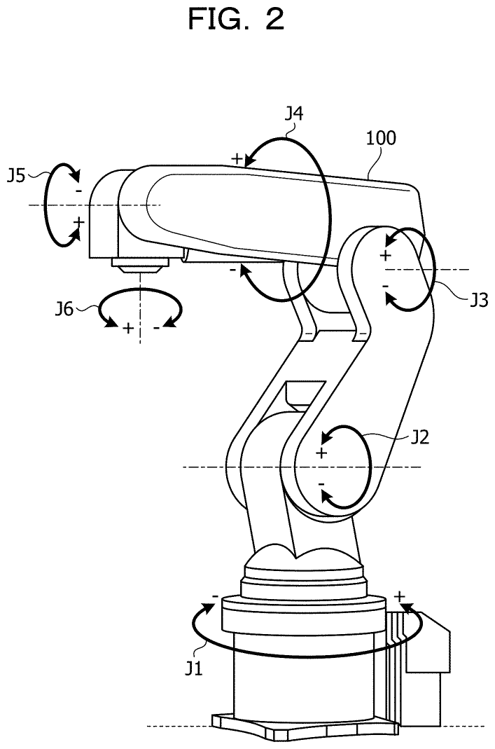

FIG. 2 is an explanatory diagram illustrating an example of the robot arm 100. As illustrated in FIG. 2, the robot arm 100 is an industrial robot arm having degrees of freedom of axes J1 to J6. As described above, a posture of the robot arm 100 having a high degree of freedom is not uniquely determined in spatial coordinates of an arm tip position. Therefore, after a trajectory of an arm for each operation is determined in advance, the machine learning model M1 which predicts posture information indicating a posture of the robot arm 100 (a change in an angle of each of the axes J1 to J6) as operation information for realizing an operation state is created by machine learning.

For example, when a current time is t, an autoencoder (AE) or the like extracts a feature amount (fₜ) representing an operation environment of the robot arm 100 from an image D1 obtained by imaging an appearance of the surroundings including the robot arm 100 at a time t (S1). For example, in a case where the autoencoder is used, a value (a latent variable) obtained from an intermediate layer by inputting the image D1 to the autoencoder is set as the feature amount (f) (the subscript t is omitted in a case of it is any time). The feature amount fₜ is an example of environmental information representing the operation environment of the robot arm 100 at the time t (current).

The feature amount fₜ is not limited to the feature amount extracted from the image D1 obtained by imaging the robot arm 100. For example, the feature amount fₜ may be extracted from an image captured by a camera installed in the robot arm 100, for example, an image captured from a viewpoint from the robot arm 100. The feature amount fₜ may be sensor data of various sensors such as a position sensor and an acceleration sensor installed in the robot arm 100 or data extracted from the sensor data via the AE or the like.

In pre-learning, current posture information (mₜ) of the robot arm 100 and the feature amount (fₜ) are input to the machine learning model M1. Next, in the pre-learning, parameters of the machine learning model M1 are set such that an estimated value (an output) of the machine learning model M1 after 1 step (t+1) at a processing timing (step) becomes the posture information (mₜ₊₁) and the feature amount (fₜ₊₁) at that time (S2).

The machine learning model M1 uses, as its own input, the estimated value (fₜ₊₁, mₜ₊₁), which is estimated (output) by the machine learning model M1 after 1 step (t+1), and further outputs the estimated value (fₜ₊₂, mₜ₊₂) of the next step (t+2). This loop process is repeated a plurality of times (for example, n times) for the machine learning model M1, so that the estimated value (fₜ₊ₙ, mₜ₊ₙ) after a plurality of steps (t+n) is output (S3). By performing the loop process in this manner, in the machine learning model M1, it is possible to perform estimation of a plurality of steps ahead from data acquired several steps before, for example, without waiting for acquisition (input) of posture information and a feature amount 1 step before.

In the present embodiment, for example, a plurality of instances (equal to or more than at least 2) are parallelized by replicating the machine learning model M1. In the present embodiment, the information (the posture information and the feature amount) acquired in the current step is input to one of a plurality of prepared machine learning models M1. Next, in the present embodiment, the acquired information is input to the machine learning model M1 while being shifted by 1 step at a time so as to be input to the other machine learning model M1 in the next step. Thus, in the present embodiment, a time interval at which operation information (m) to be used for control is obtained may be shortened in accordance with the number of machine learning models M1.

For example, in the present embodiment, by parallelizing the n machine learning models M1 that perform prediction after n steps, it is possible to predict the operation information (mₜ₊₁, . . . , and mₜ₊ₙ₋₁) in each step up to a plurality of (n) steps ahead.

As an example, in a case where the 2 machine learning models M1 for estimating after 3 steps are used, in the present embodiment, based on the feature amount (fₜ) representing an operation environment at a first timing (for example, t) and the posture information (mₜ), the posture information (fₜ₊₃) is generated by using the one machine learning model M1. Next, in the present embodiment, based on the feature amount (fₜ₊₄) representing the operation environment at a second timing (for example, t+1) and the posture information (mₜ₊₁), the posture information (fₜ₊₁) is generated by using the other machine learning model M1. Next, in the present embodiment, the operation of the robot arm 100 is controlled based on the posture information (fₜ₊₃) estimated by the machine learning model M1 at a third timing (for example, t+2). In the present embodiment, based on the feature amount (fₜ₊₂) representing the operation environment at the third timing (t+2) and the posture information (mₜ₊₂), the posture information (mₜ₊₅) is generated by using the machine learning model M1 for which the estimation is completed.

Thereafter, estimation using the machine learning model M1 and the control based on the posture information obtained by the estimation are repeated. For example, at a fourth timing (for example, t+3), the operation of the robot arm 100 is controlled based on the posture information (fₜ₊₄) estimated by the machine learning model M1 based on the information at the second timing. At a fifth timing (for example, t+4), the operation of the robot arm 100 is controlled based on the posture information (fₜ₊₅) estimated by the machine learning model M1 based on the information at the third timing.

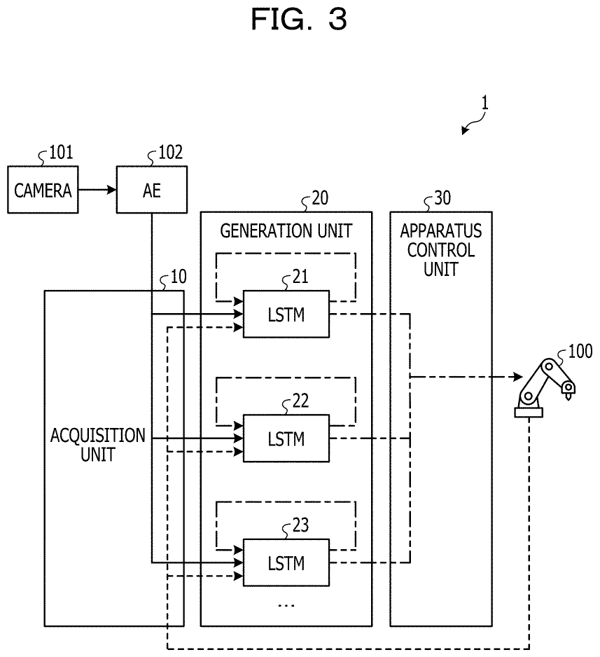

FIG. 3 is a block diagram illustrating an example of a functional configuration of the apparatus control device according to the embodiment. As illustrated in FIG. 3, the apparatus control device 1 is an information processing device that controls an operation of the robot arm 100, and includes an acquisition unit 10, a generation unit 20, and an apparatus control unit 30.

The acquisition unit 10 is a processing unit that acquires the feature amount (f) representing an operation environment of the robot arm 100 and the posture information (m) indicating an operation state of the robot arm 100. For example, the acquisition unit 10 acquires the feature amount (f) of an image obtained by inputting an image of the robot arm 100 imaged by the camera 101 to an AE 102. The acquisition unit 10 acquires the posture information (m) of each axis based on an output from a sensor (for example, an encoder) provided corresponding to the axes J1 to J6 of the robot arm 100. The acquisition unit 10 outputs the acquired feature amount (f) and posture information (m) to the generation unit 20.

The generation unit 20 is a processing unit that generates, from the feature amount (f) and the posture information (m) acquired by the acquisition unit 10, the posture information (m) several steps (for example, after n steps) after the acquisition, which is used to control the operation of the robot arm 100. For example, the generation unit 20 has a plurality of (for example, n) LSTMs 21 corresponding to the machine learning models M1 for estimating the feature amount (f) and the posture information (m) after n steps, from an input of the feature amount (f) and the posture information (m). From the input of the feature amount (f) and the posture information (m), each LSTM 21 estimates the feature amount (f) and the posture information (m) after n steps by repeating a loop of inputting estimated values of the feature amount (f) and the posture information (m) after 1 step.

The generation unit 20 inputs the feature amount (f) and the posture information (m) acquired by the acquisition unit 10 in a specific step to one of the plurality of prepared LSTMs 21. Next, in the next step, the generation unit 20 inputs the feature amount (f) and the posture information (m) acquired by the acquisition unit 10 to the LSTM 21 while shifting one step at a time so as to input the feature amount (f) and the posture information (m) to the other LSTMs 21. In this manner, the generation unit 20 outputs the posture information (m) obtained by using the plurality of LSTMs 21 to the apparatus control unit 30.

The apparatus control unit 30 is a processing unit that controls an operation of the robot arm 100 based on the posture information (m) generated by the generation unit 20. For example, the apparatus control unit 30 controls the operation of the robot arm 100 by using the posture information (m) generated by the generation unit 20 as a target value.

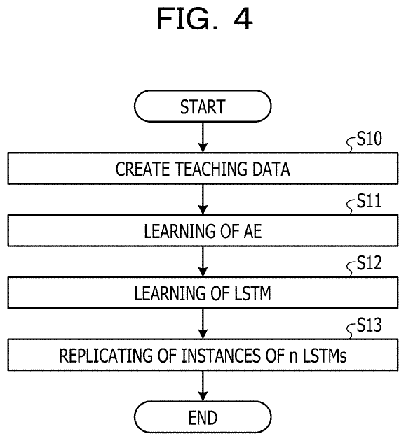

FIG. 4 is a flowchart illustrating an example of preliminary work of the apparatus control device 1 according to the embodiment. As illustrated in FIG. 4, in the preliminary work, first, an operation pattern to be learned by the robot arm 100 as an operation is manually operated approximately 10 times. The apparatus control device 1 creates teaching data by using, as a set, the image D1 of the camera 101 and the posture information (m) of the robot arm 100 at a time of this operation (S10).

For example, 20 sets are manually operated for one operation pattern including home position→hold a bolt over a table→place the bolt in a box at side→home position. Thus, the apparatus control device 1 generates teaching data for 20 sets (approximately 500 steps per 1 set)=10000 steps.

Next, in the preliminary work, learning of the AE 102 is performed based on the image D1 included in the teaching data (S11). For example, the image D1 of the teaching data created in S10 is input to the AE 102, and learning is performed so that an error between the input and an output of the AE 102 becomes small (the output of the AE 102 becomes the same as the input image D1).

For example, regarding the 10000 images D1 included in the teaching data for 10000 steps, a resolution is reduced to 300×300 pix, and the AE 102 is learned with the number of times of training set to 300 epochs.

The apparatus control device 1 sets a value (a latent variable) in an intermediate layer of the AE 102 after learning in S11 as the feature amount (f) to be input to the LSTM 21.

Next, in the preliminary work, the LSTM 21 is learned based on the feature amount (f) of the image D1 and the posture information (m) of the robot arm 100, which are included in the teaching data (S12).

For example, the LSTM 21 is learned so that a value of the teaching data at a step at a time (t+1) may be predicted by using the teaching data at the step at a time (t). At this time, the image D1 of the teaching data is input to the AE 102, and the feature amount (f) extracted from the AE 102 is input to the LSTM 21. The posture information (m) of the corresponding teaching data is directly input to the LSTM 21. A correct answer is the teaching data (the posture information (m) and the feature amount (f)) after 1 step.

In the preliminary work, a parameter of the LSTM 21 for which learning is completed is copied, and instances of the n LSTM 21 having the identical parameters are created (replicated) (S13). The number (n) of the LSTM 21 may be set by a user in advance.

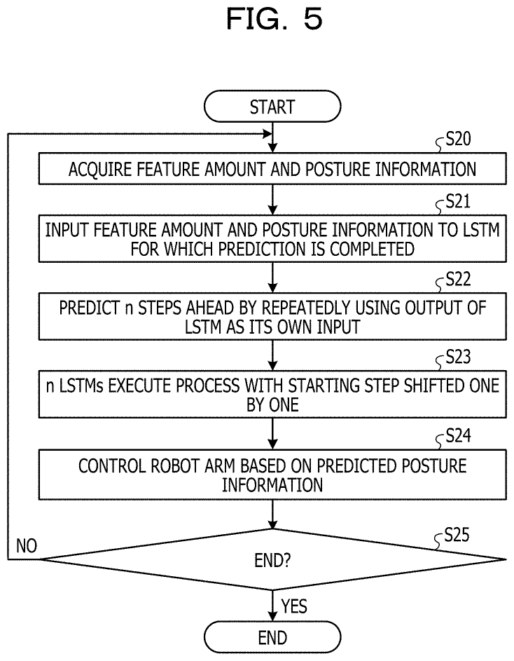

FIG. 5 is a flowchart illustrating an example of an operation of the apparatus control device 1 according to the embodiment. As illustrated in FIG. 5, when a process is started, the acquisition unit 10 acquires the feature amount (f) obtained by inputting the current image D1 to the AE 102 and the current posture information (m) of the robot arm 100 (S20).

Next, the generation unit 20 inputs the feature amount (f) and the posture information (m) acquired in S20 to the LSTM 21 for which prediction is completed and which waits for the process, among the plurality of LSTMs 21 (S21).

In the LSTM 21 which receives the input of the feature amount (f) and the posture information (m), the posture information (m) n steps ahead is predicted by a loop process in which with an output (an estimated value 1 step ahead) is repeatedly used as its own input (S22).

As described above, the generation unit 20 causes the n LSTMs 21 to execute a prediction process in parallel in a state in which a starting step is shifted one by one (S23). The generation unit 20 outputs the posture information (m) n steps ahead obtained from the LSTM 21 for which prediction n steps ahead is completed, to the apparatus control unit 30.

Next, the apparatus control unit 30 controls the operation of the robot arm 100 based on the posture information (m) predicted by the generation unit 20 (S24). Next, the apparatus control unit 30 determines whether or not an end condition is satisfied, such as whether or not the operation of the robot arm 100 reaches an end position (S25).

In a case where the end condition is not satisfied (No in S25), the apparatus control unit 30 returns the process to the S20, and continues the process related to the operation control of the robot arm 100. In a case where the end condition is satisfied (Yes in S25), the apparatus control unit 30 ends the process related to the operation control of the robot arm 100.

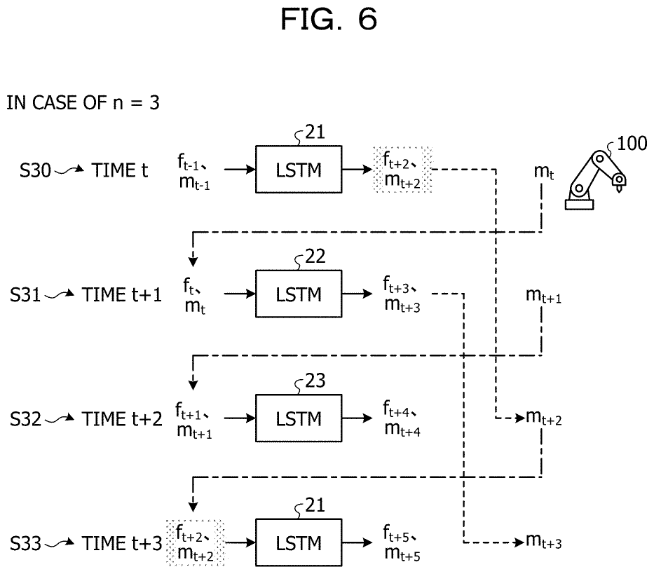

FIG. 6 is an explanatory diagram illustrating an overview of an operation in a case of n=3. For example, the example in FIG. 6 is an example of a case where the robot arm 100 is controlled by using 3 LSTMs of the LSTM 21 to 23, each of which predicts 3 steps ahead with a processing time of 1 step with respect to an input. In the illustrated example, it is assumed that it takes time (a reception time) for 1 step from acquisition of the feature amount (f) and the posture information (m) to the input to the LSTMs 21 to 23. In the same manner, it is assumed that it takes time (a transmission time) for 1 step until the feature amount (f) and the posture information (m) estimated by the LSTMs 21 to 23 are transmitted to the robot arm 100.

As illustrated in FIG. 6, at the time t, information (fₜ₋₁, mₜ₋₁) of (t−1) which is 1 step before is input to the LSTM 21 (S30). The LSTM 21 predicts the information (fₜ₊₂, mₜ₊₂) 3 steps ahead, after 1 step, and transmits the posture information (mₜ₊₂) to the robot arm 100. Thus, the robot arm 100 may obtain the posture information (mₜ₊₂) at (a time t+2) after 2 steps.

In the same manner, at the time t+1, the information (fₜ, mₜ) at the time (t), which is 1 step before, is input to an LSTM 22 (S31). The LSTM 22 predicts the information (fₜ₊₃, mₜ₊₃) 3 steps ahead, after 1 step, and transmits the posture information (mₜ₊₃) to the robot arm 100. Thus, the robot arm 100 may obtain the posture information (mₜ₊₃) at (a time t+3) after 2 steps.

In the same manner, at the time t+2, the information (fₜ₊₁, mₜ₊₁) at the time (t+1), which is 1 step before, is input to an LSTM 23 (S32). The LSTM 23 predicts the information (fₜ₊₄, mₜ₊₄) 3 steps ahead, after 1 step, and transmits the posture information (mₜ₊₄) to the robot arm 100. Thus, the robot arm 100 may obtain the posture information (mₜ₊₄) at (a time t+4) after 2 steps.

At the time t+3, the information (fₜ₊₂, mₜ₊₂) at the time (t+2), which is 1 step before, is input to the LSTM 21 which waits for the process (S33). Thus, the LSTM 21 predicts the information (fₜ₊₅, mₜ₊₅) 3 steps ahead, after 1 step, and transmits the posture information (mₜ₊₅) to the robot arm 100.

Hereinafter, by repeating the process in the same manner, in the apparatus control device 1, the posture information (m) for each one step is transmitted to the robot arm 100 as, for example, a target value, so that it is possible to control the operation of the robot arm 100. As described above, even in a case where it takes time to transmit and receive data, the apparatus control device 1 may cause the robot arm 100 to operate at a high speed and smoothly by shortening a time interval at which the operation information to be used for control is obtained.

As described above, the generation unit 20 of the apparatus control device 1 generates second operation information by using the LSTM 21, based on first environmental information representing an operation environment at a first timing and first operation information at the first timing, of an apparatus. The generation unit 20 generates fourth operation information by using the LSTM 22, based on second environmental information representing an operation environment at a second timing after the first timing and third operation information at the second timing, of the apparatus. The apparatus control unit 30 of the apparatus control device 1 controls an operation of the apparatus based on the second operation information at a third timing after the second timing. The generation unit 20 generates fifth operation information by using the LSTM 21, based on third environmental information representing an operation environment and the second operation information of the apparatus at the third timing. The apparatus control unit 30 controls the operation of the apparatus based on the fourth operation information at a fourth timing after the third timing, and controls the operation of the apparatus based on the fifth operation information at a fifth timing after the fourth timing.

As described above, since the apparatus control device 1 controls the operation of the apparatus based on the operation information obtained at each timing by using, for example, the 2 LSTMs 21 and 22, it is possible to shorten a time interval at which the operation information to be used for the control is obtained, as compared with a case where one LSTM 21 is used. Therefore, even in a case where an operation speed of the apparatus increases, the apparatus control device 1 may suppress the change amount of the operation information used for the control to a small value, smooth the movement of the apparatus, and realize a stable operation of the apparatus.

The apparatus control device 1 extracts each piece of environmental information at each timing from an image obtained by imaging an operation environment of the apparatus at each timing. As described above, the apparatus control device 1 may acquire the environmental information from the image obtained by imaging the operation environment of the apparatus at each timing.

The apparatus control device 1 generates an estimated value of the second environmental information and an estimated value of the third operation information related to the second timing after the first timing, and generates the second operation information to be used for controlling at the third timing after the second timing based on the generated estimated values, by using, for example, the LSTM 21. In this manner, by using the LSTM 21 which estimates the operation information at a timing after 1 timing, the apparatus control device 1 may estimate the operation information at a timing further ahead by one timing.

By using one of the m machine learning models M1 (m is a natural number equal to or more than 2), the generation unit 20 of the apparatus control device 1 generates operation information at an (i+n)-th timing (n=m−1), based on i-th environmental information representing an operation environment of an apparatus at an i-th timing (i is a natural number) and i-th operation information representing an operation state of the apparatus at the i-th timing. At a timing after the i-th timing ((i+n)-th timing), the apparatus control unit 30 of the apparatus control device 1 controls the operation of the apparatus based on the operation information at the (i+n)-th timing generated by the generation unit 20.

As described above, since the apparatus control device 1 controls the operation of the apparatus based on the operation information obtained by using, for example, the m machine learning models M1, it is possible to shorten the time interval at which the operation information to be used for the control is obtained, in accordance with the number of machine learning models M1, as compared with a case where one machine learning model M1 is used. For example, when n=m−1 is set, it is possible to control the operation of the apparatus based on the operation information obtained at each timing. Therefore, even in a case where an operation speed of the apparatus increases, the apparatus control device 1 may suppress the change amount of the operation information used for the control to a small value, smooth the movement of the apparatus, and realize a stable operation of the apparatus.

For example, it is assumed that it takes 2 seconds to acquire the posture information (m) of the robot arm 100, it takes 1 second for the robot arm 100 to move to a posture in the next step, and it takes 1 second to perform prediction in the machine learning model M1. In a case of using one machine learning model M1, it takes a minimum of 4 seconds to complete a round of the processes for predicting the operation information (the posture information) and operating the apparatus, as the following. 1st second: the machine learning model M1 predicts posture information (mₜ₊₁) at time t+1 from posture information (mₜ) at time t; 2nd second: the robot arm 100 moves to a posture at time t+1; 3rd second: posture information of the robot arm 100 at time t+1 is acquired (1st second); 4th second: posture information of the robot arm 100 at time t+1 is acquired (2nd second); and 5th second: the machine learning model M1 predicts posture information (m_{t+w}) at time t+2 from posture information (mₜ₊₁) at time t+1.

On the other hand, in a case where the number of machine learning models M1 is set to 4 under the above-described condition, it takes a minimum of 1 second to complete a round of the processes, as the following. 1st second: the machine learning model M1 predicts a posture at time t+2 from posture information (mₜ₋₂) at time t−2, the robot arm 100 moves to a posture at time t+1, and posture information of the robot arm 100 at time t is acquired (1st second); 2nd second: the machine learning model M1 predicts a posture at time t+3 from posture information (mₜ₋₁) at time t−1, the robot arm 100 moves to a posture at time t+2, posture information of the robot arm 100 at time t+1 is acquired (1st second), and posture information of the robot arm 100 at time t is acquired (2nd second); 3rd second: the machine learning model M1 predicts a posture at time t+4 from posture information (mₜ) at time t, the robot arm 100 moves to a posture at time t+3, posture information of the robot arm 100 at time t+2 is acquired (1st second), and posture information of the robot arm 100 at time t+1 is acquired (2nd second); and 4th second: the machine learning model M1 predicts a posture at time t+5 from posture information (mₜ₊₁) at time t+1, the robot arm 100 moves to a posture at time t+4, posture information of the robot arm 100 at time t+3 is acquired (1st second), and posture information of the robot arm 100 at time t+2 is acquired (2nd second).

It is noted that each of the components of each of the devices illustrated in the drawings is not necessarily physically configured as illustrated in the drawings. For example, specific forms of the separation and integration of each device are not limited to those illustrated in the drawings. The entirety or part of the device may be configured by functionally or physically separating into arbitrary units or integrating into an arbitrary unit in accordance with various loads, usage situations, and the like.

All or some of the various processing functions of the acquisition unit 10, the generation unit 20, and the apparatus control unit 30, to be executed in the apparatus control device 1 may be executed in a central processing unit (CPU) (or a microcomputer, such as a microprocessor unit (MPU) or a microcontroller unit (MCU)), as an example of a control unit. Of course, all or any subset of the various processing functions may be executed in programs analyzed and executed by the CPU (or a microcomputer such as the MPU or MCU) or in hardware using wired logic. The various processing functions performed in the apparatus control device 1 may be executed in such a way that a plurality of computers cooperate with each other via cloud computing.

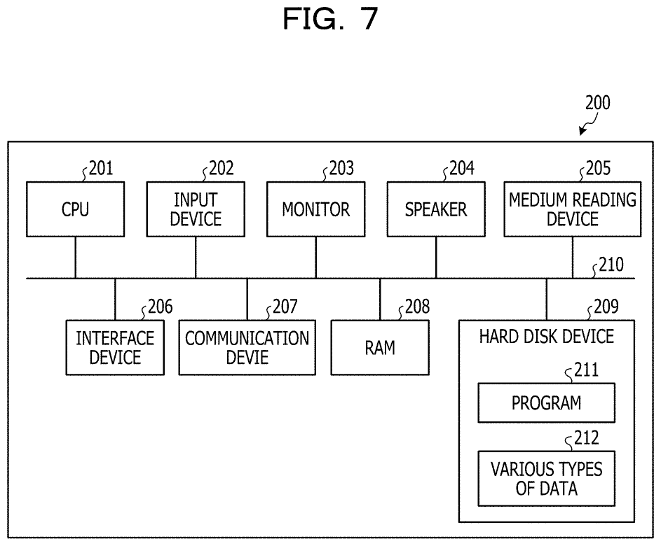

The various processes described according to the above-described embodiment may be realized when the computer executes a program prepared in advance. Hereinafter, an example of the configuration of the computer (hardware) that executes the program having functions in the same manner as those of the above-described embodiment will be described. FIG. 7 is an explanatory diagram illustrating an example of a configuration of a computer.

As illustrated in FIG. 7, a computer 200 includes a CPU 201 that executes various types of arithmetic processing, an input device 202 that accepts data input, a monitor 203, and a speaker 204. The computer 200 also includes a medium reading device 205 that reads a program or the like from a storage medium, an interface device 206 that enables coupling to various devices, and a communication device 207 that couples the computer 200 via communication to an external apparatus in a wired or wireless manner. The apparatus control device 1 also includes a random-access memory (RAM) 208 that temporarily stores various types of information and a hard disk device 209. Each of the units and the like (201 to 209) in the computer 200 is coupled to a bus 210.

The hard disk device 209 stores a program 211 for executing various processes in the functional configuration (for example, the acquisition unit 10, the generation unit 20, and the apparatus control unit 30) described in the above-described embodiment. The hard disk device 209 also stores various types of data 212 to be referred to by the program 211. The input device 202 accepts, for example, input of operation information from an operator. The monitor 203 displays, for example, various screens operated by the operator. For example, a printer or the like is coupled to the interface device 206. The communication device 207 is coupled to a communication network such as a local area network (LAN) and exchanges various types of information with the external apparatus via the communication network.

The CPU 201 reads the program 211 stored in the hard disk device 209, loads the program 211 into the RAM 208, and executes the program 211, so that various processes related to the above-described functional configuration (for example, the acquisition unit 10, the generation unit 20, and the apparatus control unit 30) are performed. The program 211 is not necessarily stored in the hard disk device 209. For example, the program 211 stored in the storage medium readable by the computer 200 may be read and executed. For example, a portable storage medium such as a compact disc read-only memory (CD-ROM), a Digital Versatile Disc (DVD), or a Universal Serial Bus (USB) memory, a semiconductor memory such as a flash memory, a hard disk drive, or the like corresponds to the storage medium readable by the computer 200. The program 211 may be stored in a device coupled to a public network, the Internet, a LAN, or the like, and the computer 200 may read and execute the program 211 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an apparatus control program for causing a computer to execute a process comprising:
generating, by using a first machine learning model, based on first environmental information representing an operation environment of an apparatus at a first timing and first operation information representing an operation state of the apparatus at the first timing, second operation information;
generating, by using a second machine learning model, based on second environmental information representing the operation environment of the apparatus at a second timing after the first timing and third operation information representing the operation state of the apparatus at the second timing, fourth operation information;
controlling an operation of the apparatus based on the second operation information at a third timing after the second timing, and generating fifth operation information, by using the first machine learning model, based on third environmental information representing the operation environment of the apparatus at the third timing and the second operation information;
controlling the operation of the apparatus based on the fourth operation information at a fourth timing after the third timing; and
controlling the operation of the apparatus based on the fifth operation information at a fifth timing after the fourth timing.

2. The computer-readable recording medium according to claim 1,
wherein the first environmental information is extracted from an image obtained by imaging the operation environment of the apparatus at the first timing.

3. The computer-readable recording medium according to claim 1,
wherein the generating of the second operation information includes generating an estimated value of the second environmental information at the second timing and an estimated value of the third operation information, and generating the second operation information based on the estimated value of the second environmental information and the estimated value of the third operation information, by using the first machine learning model.

4. An apparatus control method, performed by a computer, the method comprising:
generating, by using a first machine learning model, based on first environmental information representing an operation environment of an apparatus at a first timing and first operation information representing an operation state of the apparatus at the first timing, second operation information;
generating, by using a second machine learning model, based on second environmental information representing the operation environment of the apparatus at a second timing after the first timing and third operation information representing the operation state of the apparatus at the second timing, fourth operation information;
controlling an operation of the apparatus based on the second operation information at a third timing after the second timing, and generating fifth operation information, by using the first machine learning model, based on third environmental information representing the operation environment of the apparatus at the third timing and the second operation information;
controlling the operation of the apparatus based on the fourth operation information at a fourth timing after the third timing; and
controlling the operation of the apparatus based on the fifth operation information at a fifth timing after the fourth timing.

5. The apparatus control method according to claim 4,
wherein the first environmental information is extracted from an image obtained by imaging the operation environment of the apparatus at the first timing.

6. The apparatus control method according to claim 4,
wherein the generating of the second operation information includes generating an estimated value of the second environmental information at the second timing and an estimated value of the third operation information, and generating the second operation information based on the estimated value of the second environmental information and the estimated value of the third operation information, by using the first machine learning model.

7. An apparatus control device comprising:
a memory, and
a processor coupled to the memory, and configured to:
generate, by using a first machine learning model, based on first environmental information representing an operation environment of an apparatus at a first timing and first operation information representing an operation state of the apparatus at the first timing, second operation information;
generate, by using a second machine learning model, based on second environmental information representing the operation environment of the apparatus at a second timing after the first timing and third operation information representing the operation state of the apparatus at the second timing, fourth operation information;
control an operation of the apparatus based on the second operation information at a third timing after the second timing, and generating fifth operation information, by using the first machine learning model, based on third environmental information representing the operation environment of the apparatus at the third timing and the second operation information;
control the operation of the apparatus based on the fourth operation information at a fourth timing after the third timing; and
control the operation of the apparatus based on the fifth operation information at a fifth timing after the fourth timing.

8. The apparatus control device according to claim 7,
wherein the first environmental information is extracted from an image obtained by imaging the operation environment of the apparatus at the first timing.

9. The apparatus control device according to claim 7,
wherein the generating of the second operation information includes generating an estimated value of the second environmental information at the second timing and an estimated value of the third operation information, and generating the second operation information based on the estimated value of the second environmental information and the estimated value of the third operation information, by using the first machine learning model.

10. A non-transitory computer-readable recording medium having stored therein an apparatus control program for causing a computer to execute a process comprising:
generating operation information at an (i+n)-th timing, by using one of m machine learning models, based on i-th environmental information representing an operation environment of an apparatus at an i-th timing and i-th operation information representing an operation state of the apparatus at the i-th timing, wherein i is a natural number, n=m−1, and m is a natural number equal to or more than 2, and
controlling an operation of the apparatus at the (i+n)-th timing based on the generated operation information at the (i+n)-th timing.
